(19) United States
(12) Patent Application Publication
(10) Pub. No.: US 2013/0053481 A1
(43) Pub. Date: Feb. 28, 2013

(54) COMPOSITIONS, EMULSIONS, AND METHODS FOR MAKING COMPOSITIONS AND EMULSIONS

(71) Applicants: Eduardo Romero-Nochebuena, Porter, TX (US); Paresh Jaswantlal Sheth, Sugar Land, TX (US); Jason Lee Holder, Huntington, TX (US); Harden Christopher Wren, Lufkin, TX (US); Michael Bruce Danvers, Thorrington (GB)

(72) Inventors: Eduardo Romero-Nochebuena, Porter, TX (US); Paresh Jaswantlal Sheth, Sugar Land, TX (US); Jason Lee Holder, Huntington, TX (US); Harden Christopher Wren, Lufkin, TX (US); Michael Bruce Danvers, Thorrington (GB)

(21) Appl. No.: 13/588,738

(22) Filed: Aug. 17, 2012

Related U.S. Application Data
(60) Provisional application No. 61/525,928, filed on Aug. 22, 2011.
(60) Provisional application No. 61/540,315, filed on Sep. 28, 2011.
(60) Provisional application No. 61/594,735, filed on Feb. 3, 2012.
(60) Provisional application No. 61/655,904, filed on Jun. 5, 2012.

(51) Int. Cl. C08L 25/08; C08K 3/24; C08K 11/00; C08K 3/30

(52) U.S. Cl. 524/73; 524/401; 524/423; 524/549

(57) ABSTRACT

Compositions and methods for making compositions useful for imparting water resistance to gypsum products are disclosed. Processes for making gypsum products made from an emulsion of the composition are also disclosed. The compositions of the invention include at least one paraffin wax, a saponifiable wax, and a styrene-maleic anhydride copolymer. The composition may further include water and be in the form of an emulsion.

### RELATED APPLICATION DATA

This application claims benefit to U.S. Provisional Application No. 61/525,928, filed Aug. 22, 2011, this application claims benefit to U.S. Provisional Application No. 61/540,315, filed Sep. 28, 2011, this application claims benefit to U.S. Provisional Application No. 61/594,735, filed Feb. 3, 2012, this application claims benefit to U.S. Provisional Application No. 61/655,904, filed Jun. 5, 2012, of which the entire contents of the all of the applications are incorporated by reference herein.

### FIELD OF THE INVENTION

The present invention relates to wax emulsions useful in imparting water resistance to gypsum products. In addition the present invention relates to methods of preparing the wax emulsions and to articles prepared there-from.

### BACKGROUND OF THE INVENTION

Certain properties of gypsum (calcium sulfate dihydrate) make it very popular for use in making industrial and building products; especially gypsum board. It is a plentiful and generally inexpensive raw material which, through a process of dehydration and rehydration, can be cast, molded or otherwise formed to useful shapes. The base material from which gypsum board is manufactured is the hemihydrate form of calcium sulfate (gypsum), commonly termed stucco, which is produced by the heat conversion of the dihydrate from which the water phase has been removed.

The manufacture of gypsum products generally includes preparing a gypsum-containing slurry that contains gypsum and other components of the finished product, and then processing the slurry to remove the water and form and dry the remaining solids into the desired form. In one example of the making of a gypsum board, the gypsum slurry must flow onto a paper substrate. In a continuous process, the slurry/substrate combination is then sized by passing this combination between rollers. Simultaneous with this sizing step, a paper backing is positioned over the sized gypsum slurry. Accordingly, the gypsum slurry must possess sufficient fluidity so that a properly sized gypsum board can be made. Fluidity refers to the ability of the gypsum slurry to flow.

One undesirable trait of gypsum is that gypsum absorbs water, which reduces the strength of the products in which it is used and enables deleterious biological activity, such as the growth of mildew, mold, and other undesirable organism, to occur therein and thereon. Prior art products, like ordinary gypsum board, gypsum tile, gypsum block, gypsum casts, and the like have relatively little resistance to water. When ordinary gypsum board, for example, is immersed in water, the board quickly absorbs a considerable amount of water, and loses a great deal of its strength. Actual tests have demonstrated that when a 2 inch by 4 inch cylinder of gypsum board core material was immersed in water at about 70° F. (21.1 C.°), the cylinder showed a water absorption of 36% after immersion for 40 minutes.

Previous attempts to provide water-resistant properties to gypsum board include incorporation of asphalt, metallic soaps, resins, and wax additives into a aqueous gypsum slurry. The resulting materials were difficult to use and the core properties difficult to control. Other attempts at imparting water-resistant properties to gypsum boards include coating a finished gypsum product with water resistant films or coatings. Polysiloxane-based systems have also been used in attempts to impart water-resistance to gypsum board. However, the polysiloxane-based systems are both expensive and difficult to use. Polyvinyl alcohol has been used in an attempt to provide a room temperature system for use in adding water resistant properties to gypsum. However, the polyvinyl alcohol system tends to rapidly separate and thus typically requires continuous mixing prior to use, and there is also the potential for bacterial growth.

A finished gypsum product has also been coated with water resistant films or coatings. One specific example of a past attempt to provide a water-resistant gypsum product is the spraying of a molten paraffin wax or asphalt into an aqueous gypsum slurry. However, these coating applications add additional process complexity and machinery complexity to the manufacturing process as well as extending production times.

Additionally, existing products used to make wax emulsions for gypsum boards are available in less than sufficient amounts. For example, montan wax, made from lignite coal, is an existing product for use in wax emulsions for gypsum. However, montan wax is made only by a few manufacturers, and supplies and deliveries of materials have been observed to be insufficient for modern manufacturing process.

Accordingly, there is a need for a wax emulsion which is useful in imparting water-resistance to gypsum products, and which is economical to apply. There is a need for a alternative components for wax emulsions useful in imparting water-resistance to gypsum products. There also remains a need for an additive which is useful in imparting resistance to biological growth on gypsum products, and which is economical to employ.

### SUMMARY OF THE INVENTION

Embodiments of the invention are directed to compositions, emulsions, methods for making compositions and emulsions, and which may be used for providing water-resistance to a gypsum product. The composition includes at least one paraffin wax, a saponifiable wax, and a styrene-maleic anhydride copolymer. The composition may further include water and be in the form of an emulsion. In another aspect of the invention, the invention includes gypsum products prepared utilizing the composition of the invention.

In one aspect of the invention a composition is provided including at least one paraffin wax, a saponifiable wax, a styrene-maleic anhydride copolymer, and an alkali metal hydroxide. The composition may further include a hydrophilic metallic salt, an ionic dispersant, water, and combinations thereof. In another aspect of the invention, the invention includes gypsum products prepared utilizing gypsum and the composition of the invention

In another aspect of the invention, a method for making a composition is provided including providing components including at least one paraffin wax, a saponifiable wax, a styrene-maleic anhydride copolymer, and an alkali metal hydroxide, combining the components in one or more processing steps to form a resultant mixture, and homogenizing the resultant mixture.

In another aspect of the invention, a method for making a composition is provided including providing a first mixture comprising at least one paraffin wax, a saponifiable wax, an alkali metal hydroxide, and water, homogenizing the first mixture, providing a second mixture comprising a styrene-maleic anhydride copolymer, and combining the first mixture and the second mixture to form a resultant mixture.

In another aspect of the invention, an emulsion is provided for providing water-resistance to a gypsum product, including at least one paraffin wax, a saponifiable wax, a styrene-maleic anhydride copolymer, and water. The emulsion may further comprise a hydrophilic metallic salt, an ionic dispersant, an alkali metal hydroxide, and combinations thereof. In another aspect of the invention, the invention includes gypsum products prepared utilizing the emulsion of the invention.

In another aspect of the invention, a method is provided for making the emulsion for providing water-resistance to a gypsum product, including providing a mixture comprising at least one paraffin wax, a saponifiable wax, a styrene-maleic anhydride copolymer, and water, and homogenizing the resultant mixture. The mixture may further comprise a hydrophilic metallic salt, an ionic dispersant, an alkali metal hydroxide, and combinations thereof.

In another aspect of the invention, a method is provided for making the emulsion for providing water-resistance to a gypsum product, including providing a first mixture comprising at least one paraffin wax, a saponifiable wax, and water, homogenizing the first mixture, providing a second mixture comprising a styrene-maleic anhydride copolymer, and combining the first mixture and the second mixture to form a resultant mixture. The first mixture may further comprise a hydrophilic metallic salt, an ionic dispersant, an alkali metal hydroxide, and combinations thereof.

In another aspect of the invention, the composition includes at least a paraffin wax, a saponifiable wax substitute for montan wax, a styrene-maleic anhydride copolymer, and an alkali metal hydroxide. Optionally, the composition may include polyvinyl alcohol, an ionic dispersant, or both. The composition further includes water and may be in the form of an emulsion. In another aspect of the invention, the invention includes gypsum products prepared utilizing the compositions of the invention.

In another aspect of the invention, a method is provided for making an composition including providing components comprising a paraffin wax comprising a melting point from about 54° C. and about 74° C., an oil content from about 0.1% to less than 20% by weight of the wax, a saponifiable wax, wherein the saponifiable wax comprises a solidification temperature from about 60° C. to about 90° C., a saponification value from about 30 to about 120, and an acid value from about 10 to about 40, a styrene-maleic anhydride copolymer, and an alkali metal hydroxide, combining the components in one or more processing steps to form a resultant mixture, and homogenizing the resultant mixture. The method may further include the presence of water and the composition may be in the form of an emulsion. Optionally, the composition may include polyvinyl alcohol, an ionic dispersant, or both.

In another aspect of the invention, an emulsion is provided for providing water-resistance to a gypsum product, including a paraffin wax comprising a melting point from about 54° C. and about 74° C., an oil content from about 0.1% to less than 20% by weight of the wax, a saponifiable wax, wherein the saponifiable wax comprises a solidification temperature from about 60° C. to about 90° C., a saponification value from about 30 to about 120, and an acid value from about 10 to about 40, polyvinyl alcohol, and a styrene-maleic anhydride copolymer, an alkali metal hydroxide, and water. In another aspect of the invention, the invention includes gypsum products prepared utilizing the emulsion of the invention.

In another aspect of the invention, a method is provided for making an emulsion including providing components comprising a paraffin wax comprising a melting point from about 54° C. and about 74° C., an oil content from about 0.1% to less than 20% by weight of the wax, a saponifiable wax, wherein the saponifiable wax comprises a solidification temperature from about 60° C. to about 90° C., a saponification value from about 30 to about 120, and an acid value from about 10 to about 40, polyvinyl alcohol, a styrene-maleic anhydride copolymer, an alkali metal hydroxide, and water, combining the components in one or more processing steps to form a resultant mixture, and homogenizing the resultant mixture.

### DETAILED DESCRIPTION OF THE INVENTION

The present invention provides compositions and emulsions that are useful in imparting water-resistance properties to gypsum products, including, for example, gypsum patties, gypsum formulations, and gypsum boards. In addition, the compositions may be used in the manufacture of additional products, such as gypsum products having wood fiber or other lignocellulosic materials. The compositions may include at least a paraffin wax, a saponifiable wax, and a styrene-maleic anhydride copolymer. The composition may further include an alkali metal hydroxide. The composition may include water and be in the form of a wax emulsion.

The composition (and wax emulsion) may further comprise a hydrophilic metallic salt, an ionic dispersant, polyvinyl alcohol, and combinations thereof. The composition (and wax emulsion) may also further comprise a defoamer, a biocide, and combinations thereof. The composition (and wax emulsion) of the present invention may be added to mixtures of gypsum and water without adversely affecting properties of the mixture which are necessary to the manufacture of gypsum products such as gypsum board.

The composition (and wax emulsion) may be free of a montan wax, free of a non-styrene-maleic anhydride copolymer (or free of a non alpha-olefin-maleic anhydride copolymer), or both. The composition (and wax emulsion) may be free of an alkyl phenol, free of polyvinyl alcohol, free of a starch component, or combinations thereof. The composition (and wax emulsion) may further be free of a hydrophilic metallic salt, may be free of an ionic dispersant, or both.

The compositions in the form of wax emulsions of the present invention may be added to mixtures of gypsum and water involved in the manufacture of gypsum products such as gypsum board. The following description of the compositions is in view of a wax emulsion.

In one embodiment, the composition is prepared with a paraffin wax, such as paraffin slack wax, with an oil content less than 20%; a saponifiable wax, such as Montan wax; and the addition of the strene-maleic anhydride copolymer from about 5% to about 50% by weight of the wax emulsion. The alkali metal hydroxide, and any other additives may be added to the composition. Water may be provided to form an emulsion. The styrene-maleic anhydride copolymer may be provided at an addition rate from about 1% to about 50% into the pre-mix and then brought into an emulsified state by the use of a high shear mixer, homogenizer or other means or apparatus' known to those skilled in the art. Alternatively, the strene-maleic anhydride copolymer can be back added to the finished emulsion described above.

In one aspect the invention may comprise, consist essentially of, or consist of a composition prepared by the mixing of a paraffin wax, a saponifiable wax, a base or alkali metal hydroxide, such as potassium hydroxide, and styrene maleic anhydride copolymer solution. In one aspect the invention may comprise, consist essentially of, or consist of a composition of a paraffin wax, a saponifiable wax, a base or alkali metal hydroxide, such as potassium hydroxide, and styrene maleic anhydride copolymer solution. In addition the composition may include water, a biocide, an ionic dispersant, a hydrophilic metallic salt, a defoamer, and combinations thereof.

In one aspect the invention may comprise, consist essentially of, or consist of an emulsion prepared by the homogenization of an aqueous solution containing a paraffin wax, a saponifiable wax, a base or alkali metal hydroxide, such as potassium hydroxide, and an aqueous solution of a styrene maleic anhydride copolymer solution. In one aspect the invention may comprise, consist essentially of, or consist of a paraffin wax, a saponifiable wax, a base or alkali metal hydroxide, and an aqueous solution of a styrene maleic anhydride copolymer solution. In addition the emulsion may contain a biocide, an ionic dispersant, a hydrophilic metallic salt, a defoamer, and combinations thereof.

In another aspect the invention may comprise, consist essentially of, or consist of an emulsion prepared by the homogenization of an aqueous solution containing a paraffin wax, a saponifiable wax, and a base or alkali metal hydroxide, such as potassium hydroxide. In another aspect the invention may comprise, consist essentially of, or consist of a paraffin wax, a saponifiable wax, and a base or alkali metal hydroxide. In addition the emulsion may contain a biocide, one or more dispersants, hydrophilic metallic salts and a defoamer. An aqueous solution of a styrene maleic anhydride copolymer solution may then be added to the emulsion (and mixed into the emulsion).

Waxes useful in the emulsions of the invention include any suitable paraffin waxes for use with gypsum and gypsum related product (lignocellulose-gypsum product) production. Paraffin waxes are typically derived from petroleum oil distillates and are predominantly straight chain hydrocarbons. The paraffin waxes may be non-saponifiable waxes.

The paraffin waxes may have an average chain length of about 26 to 44 carbon atoms (C₂₆-C₄₄ or higher), such as an average chain length of about 29 to 32 carbon atoms (C₂₉-C₃₂). The paraffin waxes are typically of low volatility, exhibiting less than about a 10% loss, such as from 0.1% to 10% loss, in weight during standard thermogravimetric analysis.

Suitable paraffin waxes may include waxes which have a melting point of about 120° F. (about 54° C.) or greater, such as from about 130° F. to about 165° F. (about 54° C. to about 74° C.), such as from about 130° F. to about 150° F. (about 54° C. to about 66° C.), for example from about 135° F. to about 145° F. (about 57° C. to about 63° C.). Also, the oil content of these waxes is typically less than about 20% by weight, such as from about 0.1% to less than 15 wt %, for example, from about 0.1% to about 10% by weight, or, for example, from about 0.1% to less than about 1% by weight. Alternatively, the paraffin waxes may be free of an oil content, such as 0% by weight of oil content.

An example of a suitable paraffinic wax is Slack Wax G (G Wax), commercially available from Nippon Serio of Japan and Sasol Wax North America Corporation, of Hayward, Calif. “Slack Wax G” or “G-wax” is a paraffin hydrocarbon wax that has a melt point between 60-65° C., an oil content of <1%, and a Flash Point of >221° C.

In one embodiment, select waxes useful in the emulsions of the invention include paraffin waxes having desired physical properties. The paraffin waxes may have a melting point from about 57° C. (135° F.) to about 66° C. (151° F.). The paraffin waxes may have an minimum flash point of 200° C. or greater, such as from about 200° C. (392° F.) to about 245° C. (473° F.), such as from about 204° C. (399° F.) to about 243° C. (470° F.). Also, the oil content of the paraffin waxes may be less than about 1% by weight, such as from about 0.1% to less than 1 wt %, for example from about 0.4 wt % to less than about 0.7% by weight. The paraffin waxes may have an average chain length of about 29 to 32 carbon atoms (C₂₉-C₃₂). The paraffin waxes are typically of low volatility, exhibiting less than about a 10% loss in weight during standard thermogravimetric analysis.

Examples of suitable paraffin waxes include a wax selected from the group of Sasol R4242, Exxon Parvan 1370, Exxon Parvan 1380, Exxon Parvan 1420, Exxon Parvan 1451, IGI 1301A, IGI 1302A, and IGI 1304A, and combinations thereof. Exxon Parvan 1370, Exxon Parvan 1380, Exxon Parvan 1420, Exxon Parvan 1451 are commercially available from Exxon-Mobil, Inc., of Baytown, Tex. IGI 1301A, IGI 1302A, and IGI 1304A, are commercially available from International Group Incorporated, of Farmers Valley, Pa. Sasol R4242, also known as Nippon Serio 145 or Luxco FR 145, is commercially available from Sasol Wax North America Corporation, of Hayward, Calif. Sample properties for the suitable paraffin wax examples are shown in Table 1 below.

TABLE 1

| | | | | | | Average |
|---|---|---|---|---|---|---|
| | | | | | | Carbon |
| | Melt | | | Flash | | number |
| | Temp | | Oil | Temp | | Total |
| Waxes | ° C. (° F.) | | Content | ° C. (° F.) | | Paraffins |
| Sasol R4242 (Nippon | 61.3° | C. | 0.1% to | >238° | C. | 31 |
| Serio 145/Luxco FR145) | (143° | F.) | 0.4% | (460° | F.) | |
| Exxon Parvan 1370 | 57.0° | C. | 0.1% to | >204° | C. | 29 |
| | (135° | F.) | 0.7% | (400° | F.) | |
| Exxon Parvan 1380 | 57.8° | C. | 0.1% to | >204° | C. | 29 |
| | (136° | F.) | 0.6% | (400° | F.) | |
| Exxon Parvan 1420 | 60.0° | C. | 0.1% to | >210° | C. | 31 |
| | (140° | F.) | 0.6% | (410° | F.) | |
| Exxon Parvan 1451 | 61.1° | C. | 0.1% to | >210° | C. | 31 |
| | (142° | F.) | 0.5% | (410° | F.) | |
| IGI 1301A | 61.7° | C. | 0.1% to | >243° | C. | 30/32 |
| | (143° | F.) | 0.5% | (470) | | |
| IGI 1302A | 60.0° | C. | 0.1% to | >238° | C. | 30/32 |
| | (140° | F.) | 0.5% | (460° | F.) | |
| IGI 1304A | 65.6° | C. | 0.1% to | >236° | C. | 30/32 |
| | (150° | F.) | 0.7% | (460° | F.) | |

In certain embodiments, it is useful to saponify one or more of waxes for use in the emulsion. In this way, a saponified wax functions as an added surfactant or dispersant.

In one embodiment, a saponifiable wax is added the composition. Saponifiable waxes useful in this respect including waxes having an acid value or a saponification value and a melting point greater than about 180° F. (82.2° C.). The saponifiable wax may have a saponification value from about 30 to about 120, and may have an acid value (or acid number) from about 1 to about 40. Waxes which may be saponified in the emulsions of the present invention include montan wax, carnauba wax, beeswax, bayberry-myrtle wax, candelilla wax, caranday wax, castor bean wax, esparto grass wax, Japan wax, ouricury wax, retamo-ceri mimibi wax, shellac, spermaceti wax, sugar cane wax, wool-lanolin wax, and combinations thereof, among others. In one embodiment of the emulsion, the emulsion is free of a montan wax.

Montan wax is made from lignite or brown coal. One example of a montan wax is TER Montan Wax 6715, which is commercially available from Romonta GmbH located in Amsdorf, Germany. The TER Montan Wax 6715 has a solidification point from 78° C. to 84° C., an acid number from 10-25 (10-25 mg KOH/g), and a saponification number of 80-105 (80-10.5 mg KOH/g). Another example of a montan wax is TER Montan Wax Type N, which is commercially available from Romonta GmbH located in Amsdorf, Germany. The TER Montan Wax Type N has a solidification point from 78° C. to 84° C., an acid number from 22-36 (22-36 mg KOH/g), and a saponification number of 75-100 (75-100 mg KOH/g). Either one of the waxes may be referred to as “German Montan Wax” as known in the industry.

Saponification of such waxes may be accomplished by combining the wax with a strongly basic material such as an alkali metal hydroxide or other hydroxide. The alkali metal hydroxide may be selected from the group consisting of sodium hydroxide, potassium hydroxide, ammonium hydroxide, and combinations thereof. The amount of strongly basic material needed to saponify a wax may be calculated based on the saponification value of the wax. For example, the saponification value divided by 1000 equals the grams of potassium hydroxide to add per gram of wax.

In one embodiment, the alkali metal hydroxide may be used in an amount from about 0.01% to about 4%, such as from about 0.15% to about 1.5%, for example, from about 0.15% to about 0.5% by weight based on the total weight of the composition or emulsion. The alkali metal hydroxide may be selected from the group consisting of potassium hydroxide, sodium hydroxide, and combinations thereof. Additionally, ammonium hydroxide may be used separately, or in combination with the alkali metal hydroxide, in the emulsion. Alternatively, an amine compound or an amide compound that can saponify the saponiafiable waxes described herein may be used in combination with the alkali metal hydroxide or as a substitute for the alkali metal hydroxide. The alkali metal hydroxide may be added in an aqueous solution, for example, about 45% potassium hydroxide in an aqueous solution.

Alternatively, a saponifiable wax substitute for montan wax (also referred to as a montan wax substitute) may be used for the saponifiable wax. The saponifiable wax substitute for montan wax is characterized by a mixture of components including a petroleum derived wax base material, such as paraffin (straight-chained hydrocarbons), microcrystalline waxes (branched chained hydrocarbons), or both. The saponifiable wax substitute for montan wax may further include one or more organically derived waxes, a carboxylic acid, and optionally, other organic components, such as triglycerides and ketones, among others. In contrast, montan wax is made from lignite or brown coal. For example, the saponifiable wax substitute for montan wax may comprise a microcrystalline wax derived from petroleum, carnuba wax, and stearic acid, and may further include residual hydrocarbon materials, such as triglycerides, alcohols, and esters. Thus, a composition having a saponifiable wax substitute for montan wax may be free of a montan wax.

The saponifiable wax substitutes for montan wax may have a saponification value from about 30 to about 120, such as from about 45 to about 110, for examples from about 80 to about 105. The saponifiable wax substitutes for montan wax may have an acid number of from about 10 to about 40, such as from about 12 to about 36, for example from about 15 to about 35. Suitable saponifiable wax substitutes for montan wax include waxes having a combined acid number and saponification value in the combined range from about 40 to about 160, such as from about 50 to about 140, for example, from about 55 to about 120. The saponifiable wax substitutes for montan wax may have a solidification temperature from about 60° C. to about 90° C., such as from about 65° C. to about 85° C.

In one embodiment, the saponifiable wax substitute for montan wax, and a montan wax and/or other saponifiable wax as described herein may be used in combination for the composition. In such an embodiment, the montan wax and/or other saponifiable wax as described herein may be used in an amount comprising about 5% or less, such as from 0.1% to 5%, by weight of the composition or emulsion.

Examples of suitable saponifiable wax substitutes for montan wax include 2432 Montan Wax Substitute, 2437 Montan Wax Substitute, 2438 Montan Wax Substitute, and combinations thereof. 2432 Montan Wax Substitute, 2437 Montan Wax Substitute, and 2438 Montan Wax Substitute, are commercially available from The British Wax Refining Co., Ltd., of The United Kingdom. The properties for the above waxes are shown in Table 2 below. Other waxes believed to be suitable for use in the emulsion include 2431 Montan Wax Substitute and 2436 Montan Wax Substitute, and which waxes may be used in combination or as substitutes for the 2432 Montan Wax Substitute, 2437 Montan Wax Substitute and 2438 Montan Wax Substitute described herein. 2431 Montan Wax Substitute and 2436 Montan Wax Substitute are commercially available from The British Wax Refining Co., Ltd., of The United Kingdom.

TABLE 2

| | Solidification | | Saponification |
|---|---|---|---|
| | Temp ° C. | Acid Value | Value |
| Waxes | ASTM D938 | ASTM D1386 | ASTM D1387 |
| 2432 Montan Wax | 65-72° C. | 12-25 | 45-60 |
| Substitute | | | |
| 2437 Montan Wax | 78-84° C. | 15-35 | 80-105 |
| Substitute | | | |
| 2438 Montan Wax | 78-84° C. | 15-35 | 80-105 |
| Substitute | | | |
| 2431 Montan Wax | 75-80° C. | 22-36 | 75-100 |
| Substitute | | | |
| 2436 Montan Wax | 78-84° C. | 15-25 | 80-105 |
| Substitute | | | |

Typical composition ranges for the emulsion of the invention useful in providing water-resistance to a gypsum product include any combination of the following. The at least one paraffin wax may be present in the emulsion in an amount of about 25% to about 50% by weight, such as from about 30% to about 40% by weight, based on the total weight of the composition or emulsion. A saponifiable wax may be present in an amount from about 0.5% to about 5% by weight, such as from about 2.5% to about 4.5% by weight or from about 1.5% to about 2.5% by weight, based on the total weight of the composition or emulsion. Water may be present in an amount of about 45% to about 65% by weight based on the total weight of the emulsion to form the emulsion.

The styrene-maleic anhydride copolymer may comprise one or more copolymers of styrene and maleic anhydride, one or more derivatives of a copolymer of styrene and maleic anhydride, or a combination thereof. The styrene-maleic anhydride copolymer may be obtained by the copolymerization of styrene and maleic anhydride. The derivative may be formed by further reacting the copolymer with functional groups to end-cap the copolymer, by esterfication of the copolymer, by forming a salt of the copolymer, and by hydrolysis of the copolymer, among other post polymerization reactions, to form a derivative thereof. The styrene-maleic anhydride copolymer may be used as a surfactant in the composition.

The styrene-maleic anhydride copolymer may be present in the composition or emulsion in an amount from about 0.1% to about 50% by weight. In one embodiment of the composition, the styrene-maleic anhydride copolymer may be present in an amount from about 1% to about 15% by weight, for example, from about 3% to about 12% by weight, based on the total weight of the composition or emulsion. In one embodiment of the composition, styrene-maleic anhydride copolymer may be present in the emulsion in an amount from about 0.1% to about 12% by weight, such as about 0.5% to about 6%, for example, from about 1% to about 3%, based on the total weight of the composition or emulsion. Styrene-maleic anhydride copolymer may be provided as a solution, such as 25% styrene-maleic anhydride copolymers in an aqueous solution.

Suitable styrene-maleic anhydride copolymers include a styrene-maleic anhydride copolymer, a hydrolyzed styrene-maleic anhydride copolymer, a cumene end-capped styrene-maleic anhydride copolymer, an ammonium salt of cumene end-capped styrene-maleic anhydride copolymer, a sodium salt of cumene end-capped styrene-maleic anhydride copolymer, an ammonium salt of styrene-maleic anhydride copolymer, a sodium salt of styrene-maleic anhydride copolymer, a styrene-maleic anhydride copolymer ester formed from the partial esterfication of styrene-maleic anhydride copolymer, styrene-maleic anhydride amic acid copolymer, copolymers of styrene and dimethylaminopropylamine maleimide, sulfonated styrene-maleic anhydride copolymer, and combinations thereof. Examples of styrene-maleic anhydride copolymers include SMA™ 1000 copolymer, SMA™ 2000 copolymer, SMA™ 3000 copolymer, SMA™ 1000H copolymer, SMA™ 1000P copolymer, SMA™ 1440H copolymer, SMA™ 2000H copolymer, SMA™ 3000H copolymer, SMA™ 3000P copolymer, SMA™ 17352H copolymer, SMA™ 1000K copolymer, SMA™ 3000K copolymer, SMA™ 3000Na copolymer, and combinations thereof, commercially available from Cray Valley USA LLC, of Exton, Pa.

The styrene-maleic anhydride copolymer may have a molecular weight from about 800 to about 100,000, such as from about 1,000 to about 50,000, for example, from about 5,000 to about 25,000. The styrene-maleic anhydride copolymer may be provided in a solid form, or an aqueous solution form. In a solid form, such as powder, the styrene-maleic anhydride copolymer may have a melt viscosity at 200° C. from about 70 to about 60,000, an acid value (acid number) from about 95 to about 495, a glass transition temperature (Tg) from about 45° C. to about 155° C., or combinations thereof.

The solutions of styrene-maleic anhydride copolymer may have a solids content from about 10% to about 41% by weight of the solution, a pH from about 8 to about 12, a viscosity (cps as 30° C.) from 100 cps to 15000 cps, a Gardner color of less than 5, such as from 1 to less than 5, and combinations thereof. In one example, an ammonium salt of styrene-maleic anhydride copolymer may be provided as a 35.5% solids aqueous solution.

The molar ratio of styrene to maleic anhydride in the copolymer or copolymer derivative form may be in a range of from about 1:1 to about 8:1, such as from about 1:1 to about 3:1. In one embodiment the styrene-maleic anhydride copolymer of the emulsion may comprise a mixture of two or more separate styrene-maleic anhydride copolymers, with each copolymer having independent and/or different molar ratios of styrene to maleic anhydride. For example, in one example, the styrene-maleic anhydride copolymer may comprise a first copolymer having a molar ratio of styrene to maleic anhydride of about 1:1 and a second copolymer having a molar ratio of styrene to maleic anhydride of about 3:1 to form a copolymer mixture having a molar ratio of styrene to maleic anhydride from about 1.65:1 to about 1.8:1.

In an embodiment having two or more separate styrene-maleic anhydride copolymers, each of the separate copolymers may comprise from 1% to 99% by weight of the combined copolymers, up to a total amount of 100% of all the copolymers of the to styrene-maleic anhydride copolymer mixture. For example, the styrene-maleic anhydride copolymer may comprise 50% by weight of SMA™ 1000K copolymer and 50% by weight of SMA™ 3000K copolymer.

Alternatively, an olefin-maleic anhydride copolymer may be used as a substitute for, or in combination with, the styrene-maleic anhydride copolymer as described herein. Suitable olefin-maleic anhydride copolymers include α-olefins having from 4 to 6 carbon atoms or an olefin having from 4 to 60 carbon atoms and having a double bond at the α-position obtained by the oligomerization of an α-olefin having from 2 to 5 carbon atoms such as ethylene, propylene, isobutylene or isoamylene, with maleic anhydride; a copolymer having a molecular weight of 200 to 3000 obtained by copolymerizing such an α-olefin with maleic anhydride by a radical initiator; or a partially esterified product thereof with an organic monohydroxy compound. The molar ratio of the olefin to the maleic anhydride or its partially esterified product may be within the range of from 3:1 to 1:2. The olefin-maleic anhydride copolymer and the combination of the olefin-maleic anhydride copolymer and the styrene-maleic anhydride copolymer may be present in the emulsion in an amount from about 0.1% to about 10% by weight.

The organic monohydroxy compound used for the formation of the partially esterified product includes an alcohol such as methanol, ethanol, isopropanol, butanol or 2-ethylhexanol; a cellosolve such as butyl cellosolve or ethyl cellosolve; a long chain alkyl alcohol such as stearyl alcohol or oleyl alcohol; an aryl alcohol such as nonylphenol, dodecylphenol or styrene-modified phenol; and an adduct of ethylene oxide with the above-mentioned long chain alkyl alcohol, an aryl alcohol or an alkylamide such as stearylamide or oleylamide or a polypropylene glycol having a molecular weight of from 1000 to 10,000. Such an organic monohydroxy compound is used in an amount of not more than 1 mol relative to 1 mol of maleic anhydride. The preparation of the partially esterified product may be conducted after the reaction of the olefin with maleic anhydride, or by the reaction of a partially esterified product of maleic anhydride with an olefin.

The styrene-maleic anhydride copolymer compositions comprising one or more styrene-maleic anhydride copolymers can be prepared, for example, by reacting a combination of a first styrene-maleic anhydride copolymer, for example, 1000P, and a second styrene-maleic anhydride copolymer, for example, 3000P, with KOH 45% in an aqueous solution. 1000P is described as styrene-maleic anhydride resin with a mole ratio of Styrene/Maleic anhydride of about 1:1. 3000P is a styrene-maleic anhydride resin with a mole ratio of styrene/maleic anhydride of about 3:1. The styrene-maleic anhydride copolymer compositions can be solubilized in an aqueous solution by reacting with an alkaline or amine material. The level of alkaline or amine material is dependant on the acid number and weight of styrene-maleic anhydride copolymer being used. The materials are then combined and heated at a prescribed temperature and time to form the styrene-maleic anhydride copolymer composition.

The composition, and emulsion, may include additional components. Additional components include a hydrophilic metallic salt, an ionic dispersant, polyvinyl alcohol, and combinations thereof, which may also be used with the waxes in the emulsions described herein.

The composition or emulsion may include a hydrophilic metallic salt, such as magnesium sulfate (MgSO₄). Suitable hydrophilic metallic salts include magnesium sulfate, potassium sulfate, lithium sulfate, ammonium sulfate, potassium acetate, ammonium heptamolybdate, and combinations thereof. The hydrophilic metallic salt, such as magnesium sulfate (MgSO₄), may be present in the composition or emulsion in an amount of about 0.05% to about 5% by weight, such as about 0.05% to about 3.0%, for example, from about 0.1% to about 2.5%, and in a further example, between about 0.1% to about 1.0%, based on the total weight of the composition or emulsion.

It is believed that the hydrophilic metallic salt eliminates the use of starch as a suspension/gelation aid, and to be compatible with a wider range of available waxes (i.e. lower cost/lower melt point waxes). Examples of the starches utilized as a suspension/gelation aid are described in US Patent Application Publication No. 2005/0250858 A1 and in U.S. Pat. No. 6,663,707, both of which are incorporated herein by reference. Thus, the composition or emulsion may be free of a starch component.

Additionally, hydrophilic metallic salts, such as MgSO₄, are believed to be water soluble and offer an opportunity to disperse wax, suspended as an emulsion, more uniformly through a stucco/core substrate, and to be compatible with a wider range and lower cost/lower melt point of available waxes. The MgSO₄ containing emulsion of the present invention also allows a reduction in the use of the alkylated phenol, which functioned as a dispersant in the historic system. As a result the wax emulsion of the present invention is significantly more stable than former or competitive systems and may be stored at higher solids content, with out comprising the performance or stability of the emulsion. The emulsion may be free of alkyl phenols. As used herein, “alkyl phenols” refer to phenolic compounds having a long chain alkyl group.

An ionic dispersant may also be used in the composition. The ionic dispersant may include cationic materials, such as cationic surfactants. The ionic dispersant may include a compound selected from the group of polynaphthalenesulfonic acid (including condensates), a lignosulfonate (including condensates), and combinations thereof. In embodiments of the compositions utilizing a saponifiable wax substitute for montan wax, the ionic dispersants may be selected from the group of a polynaphthalenesulfonic acid, sodium naphthalene sulfonate, a lignosulfonate, a polynaphthalene sulfonate calcium salt, and combinations thereof. The ionic dispersant may be used in an amount of about 0.25% to about 5.0% by weight based on the total weight of the composition or emulsion. An example of a polynaphthalenesulfonic acid ionic dispersant is DISAL™ surfactant from Handy Chemicals Limited Corporation of Canada. An example of a lignosulfonate ionic dispersant is POLYFON™ H surfactant commercially available from MeadWestvaco Corporation of Richmond, Va. Examples of polynaphthalene sulfonate calcium salt ionic dispersants are Durasar surfactant and Gypsperse surfactant from Handy Chemicals Limited Corporation of Canada. The dispersant may be added in a solution, such as DISAL™ surfactant, which contains about 40% sodium naphthalene sulfonate in an aqueous solution.

The ionic dispersant may be present in an amount of about 0.1% to about 5.0% by weight based on the total weight of the emulsion, such as from about 0.2% to about 2%, for example from about 0.24% to about 0.4%, by weight based on the total weight of the emulsion. In one embodiment, the ionic dispersant comprises a mixture of a polynaphthalenesulfonic acid, a lignosulfonate, and polynaphthalene sulfonate calcium salt, and the ionic dispersant mixture comprises from about 0.25% to about 5.0% by weight based on the total weight of the emulsion. The dispersant may be added in a solution, such as DISAL™ surfactant, which contains about 40% sodium naphthalene sulfonate in a aqueous solution.

The compositions described herein may be free of polyvinyl alcohol or a derivative thereof, such as polyvinyl acetate.

Optionally, in some embodiments of the composition, the composition may also include polyvinyl alcohol (PVOH). In compositions having polyvinyl alcohol, the ionic dispersant may or may not be used. Thus, in one embodiment, the composition may comprise at least a paraffin wax, a saponifiable wax substitute for montan wax, polyvinyl alcohol, and a styrene-maleic anhydride copolymer. The composition may further include an alkali metal hydroxide, an ionic dispersant as described herein, or both. The composition may include water and be in the form of a wax emulsion. Additionally, the polyvinyl alcohol-containing composition may be free of a montan wax, free of a non-styrene-maleic anhydride copolymer (or free of a non alpha-olefin-maleic anhydride copolymer), free of an ionic dispersant, or combinations thereof.

The polyvinyl alcohol may have a viscosity from about 1 centipoise (cps) to about 11 cps, such as from about 2.5 cps to about 4.5 cps. The polyvinyl alcohol may have a molecular weight from about 13,000 to about 23,000. The polyvinyl alcohol may by hydrolyzed from at greater than 85%, such a greater than 95%, for example hydrolyzed from about 98% to 99%. The polyvinyl alcohol may be present in the composition or emulsion in an amount from about 0.01% to about 5% by weight, such as about 0.05% to about 2.5%, for example, at about 0.12%, based on the total weight of the composition or emulsion.

The polyvinyl alcohol may be in the form of a solid or an aqueous solution, for example, polyvinyl alcohol (PVOH) may be provided in an aqueous solution of 20% PVOH, for example, in CELVOL™ 103, commercially available from Seikisui Inc, of Japan. The CELVOL™ 103 solution is a substantially hydrolyzed vinyl acetate copolymer at a concentration of equal to or greater than 92% and a percent hydrolysis equal to or greater than 87%, for example, from abut 98 to about 98.8%. CELVOL™ 502 is a partially hydrolyzed vinyl acetate copolymer at a concentration of >92% and a percent hydrolysis between 87-89%, which is provided in an aqueous solution of 20% PVOH.

An optional component for the emulsions or gypsum formulations described herein includes a biocide, which may also be referred to as a preservative. The biocides disclosed herein are useful for inhibiting biological growth, for example, the growth of mildew, fungi, bacteria, algae, and other microorganisms, on gypsum products. As used herein biocides includes such compounds as bactericides, fungicides, algaecides, mildewcides, or a combination thereof.

The biocide may be chosen according to (1) the target organism; (2) solubility characteristics; (3) stability to the temperature and pH; and other conditions found in the manufacture of the gypsum product. Biocides include substances that kill or inhibit the growth of microorganisms such as molds, mildew, slimes, fungi, bacteria, etc. Fungicides include substances that kill or inhibit the growth of fungi. More specific examples of biocides include, but are not limited to, chlorinated hydrocarbons, organometallics, halogen-releasing compounds, metallic salts, organic sulfur compounds, and phenolics. Preferred biocides have the general structure of a heterocycle containing nitrogen and sulfur, for example, thiabendazole [2-(4-thiazolyl)-1H-benzimidazole].

Exemplary biocides (preservatives) include the compositions disclosed in U.S. Pat. No. 3,370,957 to Wagner et al., and U.S. Pat. No. 7,294,189 to Wantling which are incorporated in their entirety herein, and which discloses biocides according to the general structure (I):

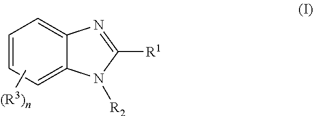

wherein R¹ can be a heterocycle containing nitrogen and sulfur, such as thiazolyl, isothiazolyl, or thiadiazolyl, which can optionally be substituted with C₁-C₆ alkyl; R² can be hydrogen or C₁-C₆ alkyl, specifically hydrogen; n is 0, 1, 2, or 3; each instance of R³ can independently be hydrogen, C₁-C₆ alkyl, phenoxy, C₁-C₆ alkoxy, halo, amino, C₁-C₆ alkylamino, di C₁-C₆ alkyl amino, imidazolyl, thiazolyl, isothiazolyl, thiadiazolyl, thienyl, furyl, pyrryl, naphthyl, phenyl, halophenyl, C₁-C₆ alkyl phenyl, C₁-C₆ alkoxyphenyl, and the like.

Particular embodiments of the mildewcide include those according to the general structures (II) and (III):

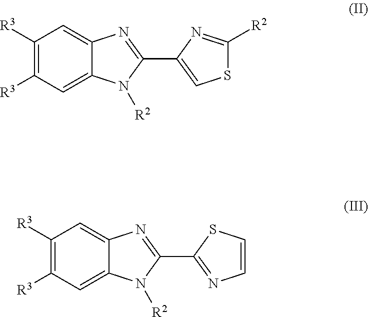

, wherein R¹, R², and R³ are as defined previously.

Exemplary mildewcides according to structure (I) include: 2-(4′-thiazolyl) benzimidazole; 2-[3′-(1′,2′,5′-thiadiazolyl]benzimidazole; 2-(4′-thiazolyl)-5-methoxy benzimidazole; 2-(4′-thiazolyl)-5-phenoxy benzimidazole hydrochloride; 2-(2′-methyl-4′-thiazolyl)benzimidazole; 2-[4′-(1′,2′,3′-thiadiazolyl)]benzimidazole; 1-acetyl-2-(4′-thiazolyl)-5-phenyl benzimidazole; 2-(4′-isothiazolyl)benzimidazole; 2-(4′-thiazolyl)-6-fluoro benzimidazole; 2-(4′-thiazolyl)-5-amino benzimidazole; 2-(2′-thiazolyl)-5-(1′-imidazolyl)benzimidazole; 2-(4′-isothiazolyl)-5-chlorobenzimidazole; 2-(4′-thiazolyl)-5-phenyl benzimidazole; 2-[4′-(1′,2′,3′-thiadazolyl)]-5-(4′-tolyl)benzimidazole; 1-acetyl-2-(2′-thiazolyl)-5-phenyl benzimidazole; 1-methyl-2-(2′-isothiazolyl)-5-(2′-methoxyphenyl) benzimidazole; 2-(4′-isothiazolyl)-5-furyl benzimidazole; 2-(4′-thiazolyl)-5-(4′-fluorophenyl)benzimidazole hydrochloride; 2-(4′-thiazolyl)-5-bromo benzimidazole; 2-(4′-thiazolyl)-5-chloro benzimidazole; 2-(2′-thiazolyl)-5-methoxy benzimidazole; 2-(4′-thiazolyl)-5-(2′-fluorophenyl)benzimidazole hydrochloride; 2-[3′-(1′,2′,5′-thiadiazolyl) 1-5-methylthio benzimidazole; 2-(4′-thiazolyl)-5,6-difluoro benzimidazole; 1-benzoyl-2-(4′-thiazolyl)benzimidazole; 2-(2′-thiazolyl)-5-(2′-pyrryl)benzimidazole; 1-methyl-2-(4′-isothiazolyl)benzimidazole hydrochloride; 2-(4′-thiazolyl)-5-phenoxy benzimidazole; 2-[3′-(1′,2′, 5′-thiadiazolyl)1-5-methoxy benzimidazole; 1-ethyl-2-(4′-thiazolyl)-5-(2′-thiazolyl)benzimidazole; 1-acetyl-213′-(1′,2′,5′-thiadiazolyl)]-5-(2″-furyl)benzimidazole; 2-(4′-thiazolyl)-4-fluoro benzimidazole hydrochloride; 2-(2′-thiazolyl)benzimidazole; 1-acetyl-2-(4′-thiazolyl)benzimidazole; and combinations thereof. In a particular embodiment described below, thiabendazole (2-(4′-thiazolyl)benzimidazole) has been found to be effective in inhibiting the growth of biological agents on gypsum board, thus indicating the advantageous utility of benzimidole compounds generally and the other biocides indicated herein.

In one embodiment, the biocide is added as the last ingredient in the wax emulsion, for example, the biocide is added to the already-formed wax emulsion. The biocide may be present in the wax emulsion in an amount of 0.01 to 10% by weight of the wax emulsion (wt. %), optionally 0.1 to 5 wt. %, for example, 0.2 to 4 wt. %. The biocide may be added in any convenient form, including 100% solids, as a hydrated paste or in a water diluted system, for example, 25-50% active thiabendazole. The biocide is preferably added with agitation, which is believed to thoroughly disperse the biocide into the discontinuous wax phase of the emulsion. Optionally, one or more of the biocides may employed in an amount calculated to be about 0.0025% to about 0.2% by weight of the finished gypsum product. The biocide is post-added to the wax emulsion under severe agitation to any desired wax emulsion where the water phase is the continuous phase in amounts ranging from 0.01 to 5% (percent) by volume.

In one embodiment of the compositions and wax emulsion described herein comprising a paraffin wax, a saponifiable wax, a styrene-maleic anhydride copolymer, and an alkali metal hydroxide without additional components of the present invention have been observed to have desirable properties. The compositions formed exhibited a basic pH. In one embodiment the compositions may have a pH from about 8 to less than 14, such as from about 8.2 to about 13.6, for example, from about 9 to about 12. The compositions may have a viscosity from about 1 cps to about 2000 cps, such as from about 7 cps to about 300 cps. The average particle size of the solids may be from about 0.05 microns (μm) to about 15 μm, such as from about 0.1 μm to about 3.2 μm, for example, from about 0.2 μm to about 1.5 μm. Additionally, the typical mean solids content of the compositions of the invention have been observed to be at least 30% by weight, such as from about 35% to about 50% by weight, for example from about 37% to about 40% by weight, of the composition. Stability of the higher solids content emulsions are beneficial in the potential to reduce transportation costs.

The emulsions described above meet the water absorption standard of less than 5.495% per ASTM C1396 test. The emulsions described herein produced gypsum materials having a water absorption of less than 5.495% by weight, such as from about 0.01% to about 5.0%, for example, from about 0.01% to less than 3.33%.

One example of such a composition as an emulsion comprises about 32.2% by weight of Slack Wax G (G-Wax), about 2% by weight of 2437 Montan Wax Substitute, about 3% by weight of a 25% SMA 1000K, about 3% by weight of a 25% SMA 3000K, about 2% by weight of a 45.5% KOH solution, and the remainder water to form an emulsion. Such a composition exhibited a solids content of about 38.56% by weight of the emulsion.

In one embodiment of the compositions and wax emulsion described herein using comprising a paraffin wax, a saponifiable wax, a styrene-maleic anhydride copolymer, and an alkali metal hydroxide with a hydrophilic metallic salt and an ionic dispersant of have been observed to have desirable properties. The wax emulsions of the present invention have been observed to have desirable properties. The emulsions of the present invention have been observed to stable for at least one (1) week, such as for at least one (1) month, and for example, for at least 6 months. The wax emulsion formed herein also exhibited the properties as follows. The wax emulsions have a pH of less than 13, such as from about 7.5 to about 12.5, for example, from about 10 to about 12.5. The wax emulsions may have a viscosity from about 1 cps to about 300 cps, such as from about 10 cps to about 180 cps. Additionally, the typical mean solids content of the emulsions of the invention have been observed to be at least 30% by weight, preferably at least 33% by weight. In one embodiment, the solids may be present from about 33% to about 41% by weight of the emulsion. Stability of the higher solids content emulsions are beneficial in the potential to reduce transportation costs.

The wax emulsions above produced gypsum materials having a water absorption from about 0% to about 35%, such as from about 0.5% to about 5.0%, for example from about 0.8% to 3.5%. The wax emulsions produced gypsum materials having a fluidity/rheology from about 2.5 inches in patty diameter to about 4.5 inches in patty diameter, such as from about 3.5 inches in patty diameter to about 4.1 inches in patty diameter under the test as described herein.

In one embodiment of the compositions and wax emulsion described herein using comprising a paraffin wax, a saponifiable wax substitute for montan wax, a styrene-maleic anhydride copolymer, and an alkali metal hydroxide with an ionic dispersant have been observed to have desirable properties. The compositions formed herein exhibited a basic pH. In one embodiment the compositions may have a pH from about 8 to less than 14, such as from about 8.2 to about 13.6, for example, from about 9 to about 12. The compositions may have a viscosity from about 1 cps to about 2000 cps, such as from about 7 cps to about 300 cps. The average particle size of the solids may be from about 0.05 microns (μm) to about 15 μm, such as from about 0.1 μm to about 3.2 μm, for example, from about 0.2 μm to about 1.5 μm. Additionally, the typical mean solids content of the compositions of the invention have been observed to be at least 30% by weight, such as from about 35% to about 50% by weight, for example from about 37% to about 40% by weight, of the composition. Stability of the higher solids content emulsions are beneficial in the potential to reduce transportation costs.

In one embodiment of the compositions and wax emulsion described herein using comprising a paraffin wax, a saponifiable wax substitute for montan wax, a styrene-maleic anhydride copolymer, polyvinyl alcohol, and an alkali metal hydroxide have been observed to have desirable properties. The compositions formed herein exhibited a basic pH. In one embodiment the compositions may have a pH from about 8 to less than 14, such as from about 8.2 to about 13.6, for example, from about 9 to about 12. The compositions may have a viscosity from about 1 cps to about 2000 cps, such as from about 7 cps to about 300 cps. The average particle size of the solids may be from about 0.05 microns (μm) to about 15 μm, such as from about 0.1 μm to about 2.0 μm, for example, from about 0.2 μm to about 1.0 μm. Additionally, the typical mean solids content of the compositions of the invention have been observed to be at least 30% by weight, such as from about 35% to about 50% by weight, for example from about 37% to about 40% by weight, of the composition. Stability of the higher solids content emulsions are beneficial in the potential to reduce transportation costs.

The resulting wax emulsion from the compositions can be used in the preparation of gypsum products and does not have significant affect on the desired properties of the finished products, such properties including strength, facing bonds, and water resistance where applicable. Gypsum is the hemihydrate form of calcium sulfate (gypsum), and may be provided either as natural gypsum or synthetic gypsum from various sources of gypsum to be used the compositions of the present invention. Various sources of gypsum may be used with the compositions/emulsions of the present invention. However, the amount of water required to hydrate a gypsum sample will vary with the purity of the sample. The wax emulsions may be added to mixtures of gypsum and water without adversely affecting properties of the mixture which are necessary to the manufacture of gypsum products such as gypsum board and gypsum wood fiber (GWF) boards. Such properties include fluidity, formability and set time. In the manufacture of gypsum wallboard products it is important to impart water resistance to the finished product, so as to limit the maximum water absorption realized by the wallboard in a defined board soak test. For example, American Standards for Testing Materials ASTM C1396 and sub parts thereof describe such a test.

In the manufacture of conventional gypsum board, the wax emulsion enters the process and is introduced into the stucco (gypsum) slurry at a mixer just prior to being released into a forming station for the board. In the case of gypsum wood fiber process, the emulsion is introduced into the fourdiner section of a paper machine. In one embodiment, the emulsion comprises from about 1 wt. % to about 7 wt. % (% by weight), such as from about 1 wt. % to about 4 wt. %, for example about 1.5 wt. % or about 3.5 wt. %, of the combined emulsion and gypsum composition. In another embodiment, the emulsion is added in sufficient quantity to provide from 1 wt. % to about 5 wt. % of wax solids into the gypsum and emulsion composition.

The gypsum board may comprise at least gypsum, the at least one paraffin wax, the saponifiable wax, and the styrene-maleic anhydride copolymer as described above, and optionally water. The gypsum may further include additional materials, such as lignocellulosic materials, such as wood or wood fibers. The gypsum board may further include any additional composition components described herein, such as the biocide described herein.

The wax emulsions containing the components described herein may also be added to the resin used in making various kinds of panel boards that do not contain gypsum. For example, emulsions described herein are useful in improving the water resistance of lignocellulosic products, thus ameliorating the detrimental effects that absorbed water can have on such products, including dimensional instability (swelling) and biological degradation as described in the process and materials of U.S. Pat. No. 7,807,735, which is incorporated herein in its entirety.

The preparation of the emulsion containing the styrene-maleic anhydride copolymer can be completed in two ways; homogenization of the emulsion and copolymer together, or homogenization of the emulsion followed by blending in the styrene-maleic anhydride copolymer after the homogenization process.

Homogenization of the emulsion and styrene-maleic anhydride copolymers together may be achieved by combining all the components including the styrene-maleic anhydride copolymers in a vessel with sufficient agitation and heating. The temperature of the vessel or emulsion may then be held at a level just above the temperature of the highest melt point component in the system for a minimum of thirty minutes during mixing to ensure good mixing. The mixture may then be transferred through a mechanical homogenizer with a pressure setting of approximately 3500 psi. The material exiting the homogenizer may then be considered a “homogenized emulsion” and cooled to room temperature. The resulting emulsions from this process have been observed to have a particle size typically below 1 micron.

In an alternate method to prepare the emulsion, all of the components, except the styrene-maleic anhydride copolymers solutions as described herein and in the examples, are heated and mixed as described above in the method describe above. Once the emulsion has passed through the homogenizer and the temperature has been reduced to room temperature, the styrene-maleic anhydride copolymer may then be added with mixing at room temperature.

In order to provide a better understanding of the present invention including representative advantages thereof, the following examples are offered.

### EXAMPLES

Examples of the wax emulsion are provided as follows. Styrene-maleic anhydride copolymer is noted by the acronym (abbreviation) SMA in the following example section. The components are described in terms of weight percent (wt. % or %) unless otherwise noted.

### Example 1

Wax emulsions 1-3 were prepared as described herein with the following components as shown in Table 3.

TABLE 3

| Component | Amount, weight percent (wt. %) |
|---|---|
| Slack Wax G | 32.2 |
| 2437 Montan Wax Substitute | 2.0 |
| Potassium Hydroxide (45.5%) | 2.0 |
| SMA 3000P (25%) | 6.0 |
| SMA 1000P (25%) | 6.0 |
| Water | 51.8 |

The water absorption of the emulsions was tested against a control. The control was Aqualite 70, commercially available from Henry Company, of El Segundo, Calif. The Aqualite 70 control emulsions and the Wax Emulsion of Table 3 were each prepared and tested 3 times, Aqualite 70-A, 70-B, and 70-C, and Wax Emulsion 1, 2, and 3, respectively.

The emulsion and gypsum tested were performed as indicated below, and the results are shown in Table 4. All gypsum formulation test specimens were made by mixing 50 grams of stucco (the hemihydrate form of calcium sulfate) with water and the emulsion together and allowed to stand for 30 seconds. The stucco used was natural mineral stucco. The water may added at an amount from about 33 to about 34 grams of water. The Aqualite 70 emulsions and Wax Emulsions 1, 2, and 3, were provided in an amount sufficient so that each emulsion comprises about 1.5% by weight (wt. %), such as about 1.3 grams, of the gypsum formulation to be tested.

The mixtures were then mixed for an additional 30 seconds. After this second mixing, the specimens were poured out onto a flat surface from a distance of 2 inches and the diameter of the resulting patty was measured. The diameter of a patty is an index of the fluidity of the specimen. The larger the diameter, the more fluid the specimen. Patties made in the fluidity test were dried for at least 24 hours at 110° F. (43.3° C.). At the end of this time, the patties were weighed and the weight was recorded.

The dried patties were then immersed in two inches of water for two hours at a temperature of about 70° F. At the end of the two hour immersion, the patties were weighed and this wet weight was recorded. The percent water retention was then calculated based on the difference between these two recorded weights.

TABLE 4

| | Aqualite | Aqualite | Aqualite | Wax | Wax | Wax |
|---|---|---|---|---|---|---|
| Data | 70-A | 70-B | 70-C | Emulsion 1 | Emulsion 2 | Emulsion 3 |
| Parts of wax | 1.5 | 1.5 | 1.5 | 1.5 | 1.5 | 1.5 |
| per 100 stucco | | | | | | |
| parts dry basis | | | | | | |
| Wax Emulsion | 41.33 | 41.33 | 41.33 | 38.56 | 38.56 | 38.56 |
| % solids | | | | | | |
| Wax solids (g) | 0.75 | 0.75 | 0.75 | 0.75 | 0.75 | 0.75 |
| dry basis | | | | | | |
| Wax emulsion | 1.05 | 1.06 | 1.06 | 1.22 | 1.21 | 1.21 |
| water (g) | | | | | | |
| Wax emulsion | 1.80 | 1.81 | 1.81 | 1.97 | 1.96 | 1.96 |
| (g) | | | | | | |
| DI water (g) | 32.94 | 32.94 | 32.93 | 32.81 | 32.8 | 32.81 |
| Natural stucco | 50 | 50 | 50 | 50 | 50 | 50 |
| (g) | | | | | | |

Emulsion
Properties

| | | | | | | |
|---|---|---|---|---|---|---|
| pH | 12.04 | 12.04 | 12.04 | 11.91 | 11.91 | 11.91 |
| Solids | 41.33 | 41.33 | 41.33 | 38.56 | 38.56 | 38.56 |
| Viscosity | 25.8 | 25.8 | 25.8 | 40.0 | 40.0 | 40.0 |
| Cps | | | | | | |

Results of
Gypsum
Formulations

| | | | | | | |
|---|---|---|---|---|---|---|
| Weight dry | 45.33 | 46.08 | 46.00 | 45.07 | 44.66 | 47.82 |
| sample | | | | | | |
| Weight of | 53.21 | 51.80 | 46.61 | 47.29 | 45.83 | 49.41 |
| sample after | | | | | | |
| soak | | | | | | |
| Water | 17.37% | 12.42% | 1.33% | 4.93% | 2.63% | 3.33% |
| Absorption | | | | | | |
| (%) | | | | | | |

Table 4 illustrates that the composition of Table 3 produced improved water absorption or similar water absorption as compared to Aqualite 70. All component and solid values for Tables 3 and 4 are % by weight (wt. %) of the emulsion.

### Example 2

One example of a the wax emulsion includes:

| | |
|---|---|
| Paraffin wax, Nippon Serio 145 | 33.5% |
| Montan wax, TER Montan Wax 6715 | 3.5% |
| Polynapthalenesulfonic acid condensate | 0.5% |
| Lignosufonate condensate | 0.5% |
| Magnesium sulfate | 0.1% |
| 45% KOH | 0.9% |
| SMA copolymer | 7.0% |
| Water | 54.0% |

pH=12.38

solids=39.28%

The styrene-maleic anhydride (SMA) copolymer was prepared by reacting a combination of SMA 1000P and 3000P with KOH 45% in an aqueous solution. SMA 1000P and 3000P are products of Cray Valley, of Channelview, Tex. SMA 1000P is described as styrene-maleic anhydride resin with a mole ratio of Styrene/Maleic anhydride of about 1:1. SMA 3000P is a styrene-maleic anhydride resin with a mole ratio of styrene/maleic anhydride of about 3:1. According to Cray Valley literature, SMA resins can be solubilized in an aqueous solution by reacting with an alkaline or amine material. The level of alkaline or amine material is dependant on the acid number and weight of SMA being used. Once this is discovered the materials are combined and heated at a prescribed temperature and time—all of which can be found in Cray Valley literature.

The SMA solution used in Example 2 is prepared as follows:

| | |
|---|---|
| SMA 1000P | 9.11% |
| SMA 3000P | 9.11% |
| KOH (45%) | 14.91% |
| Water | 66.87% |

The materials were combined and heated to 80-90° C. for about 5 hours. The resulting polymer had a pH of about 12.71 and solids of about 36.4%. The completed polymer was given the name SMA1000K/3000K, with the “K” designating that the polymer was reacted with potassium hydroxide. Alternatively a SMA copolymer solution made of 1000P, 2000P, or 3000P could be used individually or in any combination. There are also other versions of SMA that may be used as described herein. The resulting emulsion was tested for water absorption on gypsum patties. Results are listed as Example 3-7 in the next section.

### Example 3

A series of compositions were added to a base wax emulsion as follows.

The base wax emulsion comprises:

| | |
|---|---|
| Paraffin wax, Nippon Serio 145 | 33.5% |
| Montan wax, TER Montan Wax 6715 | 3.5% |
| Polynapthalenesulfonic acid condensate | 0.5% |
| Lignosufonate condensate | 0.5% |
| Magnesium sulfate | 0.5% |
| 45% KOH | 0.75% |
| Water | 60.75% |

pH=12.5

solids=38.0%.

Nippon Serio 145, a slack wax, was used as the paraffin wax. TER Montan

Wax 6715 was used as the montan wax. DISAL™ dispersant was used as the polynaphthalenesulfonic acid component, and is commercially available from Handy Chemical, Montreal, Quebec, Canada. POLYFON™ H dispersant was used as the lignosulfonate dispersant, and is commercially available from MeadWestvaco Corporation, Stamford, Conn.

To the base wax emulsion, the following compositions were added:
2-1: the addition of 11.15% of the SMA 1000K/3000K mixture described above,
2-2: no addition of SMA polymer,
2-3: 7.5% of a SMA 1000K polymer solution,
2-4 10.8% of a SMA 3000K polymer solution.

The SMA solutions were prepared as described in the SMA preparation section above.

Additionally, two commercial compositions were also evaluated. The first commercial composition is (2-5) Aqualite 70, commercially available from Henry Company, of El Segundo, Calif. The second commercial composition is (2-6) Aqualite 800, commercially available from Henry Company, of El Segundo, Calif.

Table 5 herein lists the components and certain characteristics of the emulsion formulations utilized in the examples. Examples of wax emulsions and gypsum formulations formed from the component described herein are shown in Table 5 and Table 6.

In the preparation of the emulsions, the water and water soluble components were combined in a first mixture then heated to a temperature of between about 185° F. (85° C.) to about 205° F. (96.1° C.). The wax compounds were incorporated in a second mixture and also heated to a temperature of between about 185° F. (85° C.) to about 205° F. (96.1° C.). The aqueous and wax mixtures where then combined and the resultant mixture was then placed in a homogenizer. With homogenization it is preferred that a distribution of particle diameters ranging from about 0.001 microns to about 1.0 microns be achieved. However, the distribution of particle diameters may range from about 0.001 microns to about 5.0 microns. This level of homogenization may be attained, for example, by using a dual orifice homogenizer operating at from about 2,000 to about 4,000 psig.

Table 5 lists the values from the Example compositions described above including controls and commercial products. All percentages are in weight % unless otherwise noted.

TABLE 5

| | 3-0 | | | | | | | |
|---|---|---|---|---|---|---|---|---|
| | No wax | | | | | | | |
| Component | control | 3-1 | 3-2 | 3-3 | 3-4 | 3-5 | 3-6 | 3-7 |
| Paraffin wax, | — | 33.5 | 33.5 | 33.5 | 33.5 | — | — | 33.5 |
| Nippon Serio | | | | | | | | |
| 145 | | | | | | | | |
| TER Montan | — | 3.5 | 3.5 | 3.5 | 3.5 | — | — | 3.5 |
| Wax 6715 | | | | | | | | |
| Polynapthalen | — | 0.5 | 0.5 | 0.5 | 0.5 | — | — | 0.5 |
| esulfonic acid | | | | | | | | |
| condensate | | | | | | | | |
| Lignosufonate | — | 0.5 | 0.5 | 0.5 | 0.5 | — | — | 0.5 |
| condensate | | | | | | | | |
| Magnesium | — | 0.5 | 0.5 | 0.5 | 0.5 | — | — | 0.1 |
| sulfate | | | | | | | | |
| 45% aq. KOH | — | 0.75 | 0.75 | 0.75 | 0.75 | — | — | 0.9 |
| SMA | — | 11.15 | — | — | — | — | — | 7 |
| 1000K/3000K | | | | | | | | |
| No SMA | — | — | 0 | — | — | — | — | — |
| addition | | | | | | | | |
| SMA 1000K | — | — | — | 7.5 | — | — | — | — |
| SMA 3000K | — | — | — | — | 11.8 | — | — | — |
| Aqualite 70 | — | — | — | — | — | 100 | — | — |
| Aqualite 800 | — | — | — | — | — | — | 100 | — |
| Water | 100.00 | 60.75 | 60.75 | 60.75 | 60.75 | — | — | 54 |
| Total | 100.00 | 100.00 | 100.00 | 100.00 | 100.00 | 100.00 | 100.00 | 100.00 |

Emulsion
Properties

| | | | | | | | | |
|---|---|---|---|---|---|---|---|---|
| pH | — | 10.98 | 11.19 | 11.21 | 12.07 | 10.63 | 10.36 | 12.38 |
| Solids | — | 36.43 | 38.41 | 35.4 | 33.99 | 37.65 | 40.40 | 39.28 |
| Viscosity | — | 40.2 | 15.0 | 18.9 | 43.9 | 117.5 | 176.0 | 55.0 |
| Cps | | | | | | | | |

Results of
Gypsum
Formulations

| | | | | | | | | |
|---|---|---|---|---|---|---|---|---|
| Patty diameter | 3.56 | 3.76 | 3.73 | 4.06 | 3.50 | 3.73 | 3.34 | 3.86 |
| (inches) | | | | | | | | |
| Water | 22.67 | 1.11 | 6.59 | 0.99 | 3.22 | 0.0267 | 1.293 | 2.87 |
| Absorption | | | | | | | | |

Table 1 includes fluidity and absorption data obtained for test specimens prepared utilizing the emulsions. All gypsum formulation test specimens were made by mixing 50 grams of stucco (the hemihydrate form of calcium sulfate) with water and the emulsion together and allowed to stand for 30 seconds, then mixed for 15 seconds and poured onto a hard surface from a distance of 2 inches. The mixing amounts for the above emulsions are shown in Table 6 below.

TABLE 6

| | | Water Amount | Emulsion |
|---|---|---|---|
| Emulsion | Stucco (grams) | (grams) | Amount (grams) |
| 3-0 | 50 | 32.0 | 0.0 |
| 3-1 | 50 | 30.69 | 2.06 |
| 3-2 | 50 | 30.62 | 2.13 |
| 3-3 | 50 | 30.63 | 2.12 |
| 3-4 | 50 | 30.54 | 2.21 |
| 3-5 | 50 | 30.76 | 1.99 |
| 3-6 | 50 | 30.89 | 1.86 |
| 3-7 | 50 | 30.84 | 1.91 |

This mixture was then mixed for an additional 30 seconds. After this second mixing, the specimens were poured out onto a flat surface and the diameter of the resulting patty was measured. The diameter of a patty is an index of the fluidity of the specimen. The larger the diameter, the more fluid the specimen. Patties made in the fluidity test were dried for at least 24 hours at 110° F. (43.3° C.). At the end of this time, the patties were weighed and the weight was recorded.

The dried patties were then immersed in water for two hours. At the end of the two hour immersion, the patties were weighed and this wet weight was recorded. The percent water retention was then calculated based on the difference between these two recorded weights.

While not being held to any particular theory, it is believed that the oil content relates to effectiveness of the formation of the emulsion and the resulting gypsum formulations. High oil contents, i.e., greater than 2% detrimentally affect the performance and physical properties of those waxes used to form emulsions. Additionally, waxes without oil content are also believed to detrimentally affect the performance and physical properties of those waxes used to form emulsions.

### Example 4

Table 7 herein lists the components and certain characteristics of the emulsion formulations utilized in the examples. Examples of wax emulsions and gypsum formulations formed from the component described herein are shown in Table 7-1, Table 7-2, and Table 7-3.

In the preparation of the emulsions, the water and water soluble components were combined in a first mixture then heated to a temperature of between about 185° F. (85° C.) to about 205° F. (96.1° C.). The wax compounds were incorporated in a second mixture and also heated to a temperature of between about 185° F. (85° C.) to about 205° F. (96.1° C.). The aqueous and wax mixtures where then combined and the resultant mixture was then placed in a homogenizer. With homogenization, a distribution of micelle diameters (particles) may be ranging from about 0.05 microns to about 15 microns be achieved. This level of homogenization may be attained, for example, by using a dual orifice homogenizer operating at from about 2,000 to about 4,000 psig.

In the following examples, Compositions 1-20, the individual components are described as follows. Sasol R4242 is a paraffin wax as described in Table 1. Exxon Parvan 1370 is a paraffin wax as described in Table 1. Montan wax is a lignite coal based wax commonly used in the industry. 2437 and 2438 Montan Wax Substitutes are petroleum based waxes as described in Table 2. CELVOL™ 103 and 502 are described herein. SMA™ 3000H is a hydrolyzed styrene-maleic anhydride co-polymer with a styrene to maleic anhydride molar ratio of 3:1. SMA™ 1000H is a hydrolyzed styrene-maleic anhydride co-polymer with a styrene to maleic anhydride molar ratio of 1:1. SMA™ 1440H is a hydrolyzed styrene-maleic anhydride co-polymer with a styrene to maleic anhydride molar ratio of 1:1 with a higher molecular weight than SMA™ 1000H. SMA 17352H is a hydrolyzed styrene-maleic anhydride co-polymer with a styrene to maleic anhydride molar ratio of 1:1 with a higher molecular weight than SMA™ 1000H. SMA™ 3000P is a styrene-maleic anhydride co-polymer with a styrene to maleic anhydride molar ratio of 3:1. SMA™ 3000K is a potassium salt of a hydrolyzed styrene-maleic anhydride co-polymer with a styrene to maleic anhydride molar ratio of 3:1. SMA™ 1000K is a potassium salt of a hydrolyzed styrene-maleic anhydride co-polymer with a styrene to maleic anhydride molar ratio of 1:1. SMA™ 3000Na is a sodium salt of a hydrolyzed styrene-maleic anhydride co-polymer with a styrene to maleic anhydride molar ratio of 3:1.

TABLE 7-1

| | 1 | | | | | | | |
|---|---|---|---|---|---|---|---|---|
| Component | Control | 2 | 3 | 4 | 5 | 6 | 7 | 8 |
| Sasol R4242 | 32.2 | 32.2 | 32.2 | 32.2 | 31.5 | 32.2 | 32.2 | 32.7 |
| Montan Wax | 2.4 | — | — | — | — | — | — | — |
| Montan | — | 2.4 | 2.4 | 2.4 | 2.3 | 2.4 | 2.4 | 2.44 |
| Substitute | | | | | | | | |
| Wax (2437 | | | | | | | | |
| Montan Wax | | | | | | | | |
| Substitute) | | | | | | | | |
| PVOH | 0.6 | 0.6 | 0.6 | — | — | 0.6 | 0.6 | 0.61 |
| CELVOL ™ | | | | | | | | |
| 103, 20% | | | | | | | | |
| PVOH aq. | | | | | | | | |
| Solution. | | | | | | | | |
| PVOH | — | — | — | 0.6 | 0.6 | — | — | — |
| CELVOL ™ | | | | | | | | |
| 502, 20% | | | | | | | | |
| PVOH aq. | | | | | | | | |
| Solution. | | | | | | | | |
| 25% SMA | 3 | 3 | 3 | — | — | — | 3 | — |
| 1000H aq. | | | | | | | | |
| solution | | | | | | | | |
| 25% SMA | — | — | — | — | — | — | — | 3.05 |
| 3000P aq. | | | | | | | | |
| solution | | | | | | | | |
| 25% SMA | — | — | — | 3 | 3 | — | — | — |
| 3000H aq. | | | | | | | | |
| solution | | | | | | | | |
| 25% SMA | — | — | — | — | — | 3 | — | — |
| 1440H aq. | | | | | | | | |
| solution | | | | | | | | |
| 45% aq. KOH | 0.85 | 0.85 | 0.85 | 0.85 | 0.85 | 0.85 | 0.85 | 3.2 |
| Water | 55.5 | 60.95 | 55.5 | 60.95 | 60 | 60.95 | 60.95 | 58 |
| Total | 100.00 | 100.00 | 100.00 | 100.00 | 100.00 | 100.00 | 100.00 | 100.00 |

Emulsion
Properties

| | | | | | | | | |
|---|---|---|---|---|---|---|---|---|
| pH | 8.7 | 9.5 | 9.0 | 12.2 | 13.1 | 9.2 | 8.7 | 13.5 |
| Solids | 36.9 | 37.8 | 35.6 | 36.3 | 36.8 | 36.6 | 37.2 | 40.9 |
| Viscosity | 25.4 | 16.1 | 19.5 | 585 | 80.5 | 287.2 | 11.4 | 64.4 |
| cps | | | | | | | | |
| Particle size, | 0.55 | 0.51 | 0.48 | 0.8 | 0.52 | 0.48 | 0.52 | 4.75 |
| micron | (0.2-3) | (0.2-1) | (0.1-3) | (0.2-3) | (0.2-1) | (0.2-1) | | |
| (particle size | | | | | | | | |
| range) | | | | | | | | |

Results of
Gypsum
Formulations

| | | | | | | | | |
|---|---|---|---|---|---|---|---|---|
| Patty diameter | 4.47 | 4.5 | 4.5 | 3.2 | 4.0 | 4.01 | 4 | 3.5 |
| (inches) | | | | | | | | |
| Water | 0.04 | 0.27 | 0.27 | 0.01 | 0.19 | 0.08 | 0.01 | 0.01 |
| Absorption at | | | | | | | | |
| 3% addition | | | | | | | | |

Table 7-1 has a control of the composition described herein made with a montan wax as Composition 1. Table 7-1 illustrates that the substitute for montan wax, 2438 Montan Wax Substitute, as shown by compositions 2 and 3, produced similar emulsion properties including pH, solids, viscosity, and particle size, and results of gypsum formulations including patty diameter and water absorption, as the montan wax, which indicates that the montan wax substitute as described herein is in fact an effective substitute for montan wax. Viscosities, pH levels, and particles sizes were observed to be less when using styrene-maleic anhydride copolymers having styrene to maleic-anhydride molar ratios of 1:1 in comparison to molar ratios of 3:1 or styrene-maleic anhydride copolymers having lower molecular weights as shown by compositions 2-8 and composition 9 of Table 7-2. All component and solid values for Tables 7-1 and 7-2 are by weight of the emulsion.

TABLE 7-2

| | 1 | | | | | | | |
|---|---|---|---|---|---|---|---|---|
| Component | Control | 2 | 9 | 10 | 11 | 12 | 13 | 14 |
| Sasol R4242 | 32.2 | 32.2 | 32.2 | — | — | 32.2 | 32.2 | 32.2 |
| Exxon Parvan | — | — | — | 32.2 | 32.2 | — | — | — |
| 1370 | | | | | | | | |
| Montan Wax | 2.4 | — | — | — | — | — | — | — |
| Montan | — | 2.4 | 2.4 | 2.4 | 2.4 | — | — | — |
| Substitute | | | | | | | | |
| Wax (2438 | | | | | | | | |
| Montan Wax | | | | | | | | |
| Substitute) | | | | | | | | |
| Montan | — | — | — | — | — | 2.4 | 2.4 | 2.4 |
| Substitute | | | | | | | | |
| Wax (2437 | | | | | | | | |
| Montan Wax | | | | | | | | |
| Substitute) | | | | | | | | |
| PVOH | 0.6 | 0.6 | 0.6 | 0.6 | 0.6 | 0.6 | — | 0.6 |
| CELVOL ™ | | | | | | | | |
| 103, 20% | | | | | | | | |
| PVOH aq. | | | | | | | | |
| Solution. | | | | | | | | |
| 25% SMA | — | — | — | — | 3 | — | — | — |
| 3000H aq. | | | | | | | | |
| solution | | | | | | | | |
| 25% SMA | 3 | 3 | — | 3 | 3 | 3 | 3 | — |
| 1000H aq. | | | | | | | | |
| solution | | | | | | | | |
| 25% SMA | — | — | 3 | — | — | — | — | — |
| 17352H aq. | | | | | | | | |
| solution | | | | | | | | |
| 45% aq. KOH | 0.85 | 0.85 | 0.85 | 0.85 | 0.85 | 0.85 | 0.85 | 0.85 |
| Water | 55.5 | 60.95 | 60.95 | 60.95 | 55.5 | 60.95 | 61.55 | 63.95 |
| Total | 100.00 | 100.00 | 100.00 | 100.00 | 100.00 | 100.00 | 100.00 | 100.00 |

Emulsion
Properties

| | | | | | | | | |
|---|---|---|---|---|---|---|---|---|
| pH | 8.7 | 9.5 | 9.7 | 8.2 | 8.9 | 8.8 | 8.7 | 12.7 |
| Solids | 36.9 | 37.8 | 38.1 | 37.4 | 36.8 | 37.0 | 38.9 | 38.2 |
| Viscosity | 25.4 | 16.1 | 157.5 | 9.2 | 33.2 | 21.7 | 20.8 | 1920 |
| cps | | | | | | | | |
| Particle size, | 0.55 | 0.51 | 0.56 | 0.49 | 0.56 | 0.59 | 0.47 | 0.56 |
| micron | (0.2-3) | (0.2-1) | (0.2-3) | | (0.2-3) | (0.2-3) | (0.2-0.85) | (0.2-2.5) |
| (particle size | | | | | | | | |
| range) | | | | | | | | |

Results of
Gypsum
Formulations

| | | | | | | | | |
|---|---|---|---|---|---|---|---|---|
| Patty diameter | 4.47 | 4.5 | 3.44 | 3.8 | 4.4 | 3.94 | 3.18 | 2.29 |
| (inches) | | | | | | | | |
| Water | 0.04 | 0.27 | 0.14 | 0.01 | 0.19 | 1.22 | 3.47 | 43.28 |
| Absorption at | | | | | | (at 1.5% | (at 1.5% | (at 1.5% |
| 3% addition | | | | | | addition) | addition) | addition) |

Table 7-2 has a control of the composition described herein made with a montan wax as Composition 1 and repeats the components for Composition 2.

Composition 9 is described above. Compositions 10 and 11 using Parvan 1370 give similar results as the use of Sasol R4242, which illustrates to compositions can be used with different paraffin waxes. Compositions 12-14 of Table 7-2 illustrate that water absorption increases in the absence of PVOH and significantly increases in the absence of a SMA component. All component and solid values for Table 7-2 are % by weight of the emulsion.

TABLE 7-3

| | 1 | | | | | | |
|---|---|---|---|---|---|---|---|
| Component | Control | 15 | 16 | 17 | 18 | 19 | 20 |
| Sasol R4242 | 32.2 | 32.2 | 32.2 | 32.2 | 32.2 | 32.2 | 32.2 |
| Exxon Parvan | — | — | — | — | — | — | — |
| 1370 | | | | | | | |
| Montan Wax | 2.4 | — | — | — | — | — | — |
| Montan | — | 2.4 | 2.5 | 2.5 | 2.5 | 2.5 | 2.5 |
| Substitute | | | | | | | |
| Wax (2437 | | | | | | | |
| Montan Wax | | | | | | | |
| Substitute) | | | | | | | |
| PVOH | 0.6 | 0.6 | 0.6 | 0.6 | 0.6 | 0.6 | 0.6 |
| CELVOL ™ | | | | | | | |
| 103, 20% | | | | | | | |
| PVOH aq. | | | | | | | |
| Solution. | | | | | | | |
| PVOH | — | — | — | — | — | — | — |
| CELVOL ™ | | | | | | | |
| 502, 20% | | | | | | | |
| PVOH aq. | | | | | | | |
| Solution. | | | | | | | |
| 25% SMA | — | — | — | — | — | — | — |
| 3000H aq. | | | | | | | |
| solution | | | | | | | |
| 25% SMA | 3 | 3 | — | — | — | — | — |
| 1000H aq. | | | | | | | |
| solution | | | | | | | |
| 25% SMA | — | — | — | 1.5 | — | 1.5 | — |
| 1000K aq. | | | | | | | |
| solution | | | | | | | |
| 25% SMA | — | — | 4 | — | — | — | — |
| 3000Na aq. | | | | | | | |
| solution | | | | | | | |
| 25% SMA | — | — | — | 1.5 | 3.3 | 1.5 | 2.3 |
| 3000K aq. | | | | | | | |
| solution | | | | | | | |
| 45% aq. KOH | 0.85 | 0.85 | — | — | — | — | — |
| Water | 55.5 | 55.5 | 53.52 | 52 | 55.3 | 54.2 | 52 |
| Total | 100.00 | 100.00 | 100.00 | 100.00 | 100.00 | 100.00 | 94.23 |

Emulsion
Properties

| | | | | | | | |
|---|---|---|---|---|---|---|---|
| pH | 8.7 | 8.9 | 11.6 | 10.1 | 9.7 | 10 | 10.3 |
| Solids | 36.9 | 35.8 | 40.3 | 37.5 | 37.7 | 38.12 | 35 |
| Viscosity | 25.4 | 24.4 | 15 | 136 | 157 | 236 | 184 |
| cps | | | | | | | |
| Particle size, | 0.55 | 0.5 | 0.5 | 0.51 | 0.51 | 0.52 | 0.54 |
| micron | (0.2-3) | (0.2-1) | (0.2-1) | (0.2-1.5) | (0.2-2) | (0.2-2.5) | (0.2-2.5) |
| (particle size | | | | | | | |
| range) | | | | | | | |

Results of
Gypsum
Formulations

| | | | | | | | |
|---|---|---|---|---|---|---|---|
| Patty diameter | 4.47 | 4.1 | 2.94 | 3.5 | 3.18 | 3.59 | 3.66 |
| (inches) | | | | | | | |
| Water | 0.04 | 0.83 | 0.91 | 0.31 | 3.13 | 2.64 | 2.08 |
| Absorption (at | (at 3% | | | | | | |
| 1.5% addition) | addition) | | | | | | |

Table 7-3 illustrates that the substitute for montan wax, 2437 Montan Wax Substitute, as shown by composition 15, produced similar emulsion properties including pH, solids, viscosity, and particle size, and results of gypsum formulations including patty diameter and water absorption, as the montan wax, which indicates that the montan wax substitute as described herein is in fact an effective substitute for montan wax. Table 7-3 has a control of the composition described herein made with a montan wax as Composition 1. The pH levels were observed to be less when using styrene-maleic anhydride copolymers having styrene to maleic-anhydride molar ratios of 1:1 in comparison to molar ratios of 3:1 as shown by compositions 15-20. Viscosities were observed to increase with blended SMA compositions. Viscosities were also observed to be higher when no saponifier, potassium hydroxide, was used in the composition. All component and solid values for Table 7-3 are % by weight of the emulsion.

Tables 7-1 to 7-3 include fluidity and absorption data obtained for test specimens prepared utilizing the emulsions. All gypsum formulation test specimens were made by mixing 50 grams of stucco (the hemihydrate form of calcium sulfate) with water and the emulsion together and allowed to stand for one minute. The water may added at an amount from about 32 to about 33 grams of water, and the emulsion may be added at an amount of about 3.5 to about 4.5 grams to the stucco to form the gypsum formulation.

The mixtures were then mixed for an additional 30 seconds. After this second mixing, the specimens were poured out onto a flat surface and the diameter of the resulting patty was measured. The diameter of a patty is an index of the fluidity of the specimen. The larger the diameter, the more fluid the specimen. Patties made in the fluidity test were dried for at least 24 hours at 110° F. (43.3° C.). At the end of this time, the patties were weighed and the weight was recorded.

The dried patties were then immersed in water for two hours. At the end of the two hour immersion, the patties were weighed and this wet weight was recorded. The percent water retention was then calculated based on the difference between these two recorded weights.

While not being held to any particular theory, it is believed that the oil content relates to effectiveness of the formation of the emulsion and the resulting gypsum formulations. High oil contents, i.e., greater than 2% detrimentally affect the performance and physical properties of those waxes used to form emulsions. Additionally, waxes without oil content are also believed to detrimentally affect the performance and physical properties of those waxes used to form emulsions.

### Example 5

Additionally, emulsions were prepared using compositions having at least a paraffin wax, a saponifiable wax substitute for montan wax, an ionic dispersant, a styrene-maleic anhydride copolymer, and an alkali metal hydroxide. These emulsions were free of polyvinyl alcohol or derivatives thereof. The emulsions are shown in Table 8.

In the preparation of the emulsions, the water and water soluble components were combined in a first mixture then heated to a temperature of between about 185° F. (85° C.) to about 205° F. (96.1° C.). The wax compounds were incorporated in a second mixture and also heated to a temperature of between about 185° F. (85° C.) to about 205° F. (96.1° C.). The aqueous and wax mixtures where then combined and the resultant mixture was then placed in a homogenizer. With homogenization, a distribution of micelle diameters (particles) may be ranging from about 0.05 microns to about 15 microns be achieved. This level of homogenization may be attained, for example, by using a dual orifice homogenizer operating at from about 2,000 to about 4,000 psig.

In the following examples, Compositions 21-30, the individual components are described as follows. G-wax (Salol R4242) is a paraffin wax as described in Table 1. 2437 Montan Wax Substitute is a petroleum based waxes as described in Table 2. SMA™ 1000K is a potassium salt of a hydrolyzed styrene-maleic anhydride co-polymer with a styrene to maleic anhydride molar ratio of 1:1. SMA™ 3000K is a potassium salt of a hydrolyzed styrene-maleic anhydride co-polymer with a styrene to maleic anhydride molar ratio of 3:1 added in a 25% solution. Potassium hydroxide (KOH) is provided as a 45.5% aqueous solution. DISAL™ is a polynaphthalenesulfonic acid dispersant available from Handy Chemical, Montreal, Quebec, Canada, which may also be referred to as a sulfonated naphthalene condensate. The sodium salt of lignosulfonic acid is POLYFON™ H surfactant commercially available from MeadWestvaco Corporation of Richmond, Va. All component and solid values for Table 8 are % by weight of the emulsion.

TABLE 8

| | 21 | | | | | | | | | |
|---|---|---|---|---|---|---|---|---|---|---|
| | Control | | | | | | | | | |
| Component | No Wax | 22 | 23 | 24 | 25 | 26 | 27 | 28 | 29 | 30 |
| G-WAX | — | 33 | 34 | 34 | 33 | 30 | 30 | 30 | 33.5 | 34 |
| (Sasol | | | | | | | | | | |
| R4242) | | | | | | | | | | |
| Montan | — | 2.0 | 2.0 | 1.5 | 2 | 2.5 | 2.5 | 2.5 | 3.5 | 1.5 |
| Substitute | | | | | | | | | | |
| Wax (2437 | | | | | | | | | | |
| Montan Wax | | | | | | | | | | |
| Substitute) | | | | | | | | | | |
| 25% SMA | — | 6 | 8 | 12 | 6 | 8 | 8 | 12 | 6 | 12 |
| 1000K aq. | | | | | | | | | | |
| solution | | | | | | | | | | |
| 25% SMA | — | 6 | 0 | 0 | 6 | 4 | 0 | 0 | 6 | 8 |
| 3000K aq. | | | | | | | | | | |
| Solution | | | | | | | | | | |
| Disal ™ | — | 1 | 0.75 | 0.75 | 0 | 1 | 0.6 | 1 | 0 | 0.75 |
| Sodium salt | — | 0 | 0 | 0 | 1.0 | 0 | 0 | 0 | 1 | 0 |
| of | | | | | | | | | | |
| lignosulfonic | | | | | | | | | | |
| acid | | | | | | | | | | |
| 45% KOH | — | 0.4 | 0.45 | 0.45 | 0.4 | 0.5 | 0.55 | 0.5 | 0.75 | 0.45 |
| aq. | | | | | | | | | | |
| Water | 100 | 51.60 | 54.8 | 51.3 | 51.6 | 54 | 58.35 | 54 | 49.25 | 43.3 |
| Total | 100 | 100 | 100 | 100 | 100 | 100 | 100 | 100 | 100 | 100 |

Emulsion Properties

| | | | | | | | | | | |
|---|---|---|---|---|---|---|---|---|---|---|
| pH | 7 | 12.1 | 10.9 | 10.5 | 11.1 | 11.6 | 10.8 | 11.8 | 12.0 | 12 |
| Solids (%) | 0 | 39.2 | 37.7 | 37.0 | 39.2 | 35.9 | 35.3 | 36.7 | 41.71 | 42.5 |
| Brookfield | 1 | 75.4 | 58.6 | 52.8 | 75.8 | 128.2 | 70.6 | 57.8 | 167 | 145 |
| Viscosity | | | | | | | | | | |
| cps | | | | | | | | | | |
| Particle size, | 0 | 0.61 | 0.58 | 0.62 | 0.63 | 0.57 | 3.02 | 0.56 | 0.62 | 0.62 |
| micron | | | | | | | | | | |
| (particle size | | | | | | | | | | |
| range) | | | | | | | | | | |

Results of Gypsum
Formulation

| | | | | | | | | | | |
|---|---|---|---|---|---|---|---|---|---|---|
| Patty | 3.57 | 3.41 | 3.6 | 3.4 | 3.48 | 3.63 | 3.34 | 3.5 | 3.41 | 3.46 |
| diameter, | | | | | | | | | | |
| Slump | | | | | | | | | | |
| (inches) | | | | | | | | | | |
| Water | 39.83 | 2.58 | 1.84 | 2.5 | 1.63 | 2.31 | 3.02 | 1.57 | 1.9 | 1.19 |
| Absorption | | | | | | | | | | |
| at 1.5 | | | | | | | | | | |
| addition (%) | | | | | | | | | | |

As shown in Table 8, the compositions as described herein show significant water absorption improvement while little or no change in the patty diameter slump size. Table 8 has a control of an emulsion produced without the addition of the composition as described herein. Table 8 further illustrates that the addition of an ionic dispersant, such as Disal™ surfactant or a sodium salt of lignosulfonic acid, and eliminating the use of polyvinyl alcohol (PVOH), produced similar emulsion properties including pH, solids, viscosity, and particle size, and results of gypsum formulations including patty diameter and water absorption.

The average particle size were observed below 1 micron, only the lower mount of DISAL™ surfactant produce an average particle size higher of 3.02 microns. The water absorption at 1.5 addition (%) was at 3.02% or less. The compositions as described herein are effective for use in gypsum formulations. The pH levels were observed to be less basic when the total level of styrene to maleic-anhydride was decreased. Also, the viscosity levels and % solids of the emulsions were also observed to decrease with a decrease in the total level of styrene to maleic-anhydride.

Table 8 illustrates that the recipes including Disal™ or Sodium salt of lignosulfonic acid as ingredient and eliminating the PVOH are effective for producing low water absorbance for gypsum formulations.

While the present invention has been described and illustrated by reference to particular embodiments and examples, those of ordinary skill in the art will appreciate that the invention lends itself to variations not necessarily illustrated herein. For this reason, then, reference should be made solely to the appended claims for purposes of determining the true scope of the present invention.

What is claimed is:

1. A composition, comprising:
at least one paraffin wax;
a saponifiable wax;
a styrene-maleic anhydride copolymer; and
an alkali metal hydroxide.

2. The composition of claim 1, wherein the emulsion comprises:
a paraffin wax comprising a melting point from about 54° C. and about 74° C., an oil content from about 0.1% to less than 20% by weight of the wax;
a saponifiable wax, wherein the saponifiable wax comprises a solidification temperature from about 60° C. to about 90° C., a saponification value from about 30 to about 120, and an acid value from about 10 to about 40;
a styrene-maleic anhydride copolymer; and
an alkali metal hydroxide.

3. The composition of claim 1, further comprising water, wherein the composition comprises an emulsion.

4. The composition of claim 3, wherein the paraffin wax comprises from about 25% to about 50% by weight based on the total weight of the emulsion, and the saponifiable wax comprises from about 0.5% to about 5% by weight, based on the total weight of the emulsion.

5. The composition of claim 3, wherein the styrene-maleic anhydride copolymer comprises from about 0.1% to about 10% by weight based on the total weight of the emulsion.

6. The composition of claim 1, wherein the styrene-maleic anhydride copolymer comprises a molar ratio of styrene to maleic anhydride from about 1:1 to about 8:1.

7. The composition of claim 6, wherein the styrene-maleic anhydride copolymer comprises two or more separate styrene-maleic anhydride copolymers each having a molar ratio of styrene to maleic anhydride from about 1:1 to about 8:1.

8. The composition of claim 1, wherein the styrene-maleic anhydride copolymer comprises a styrene-maleic anhydride copolymer, a hydrolyzed styrene-maleic anhydride copolymer, a cumene end-capped styrene-maleic anhydride copolymer, an ammonium salt of cumene end-capped styrene-maleic anhydride copolymer, a sodium salt of cumene end-capped styrene-maleic anhydride copolymer, an ammonium salt of styrene-maleic anhydride copolymer, a sodium salt of styrene-maleic anhydride copolymer, a styrene-maleic anhydride copolymer ester formed from the partial esterfication of styrene-maleic anhydride copolymer, styrene-maleic anhydride amic acid copolymer, copolymers of styrene and dimethylaminopropylamine maleimide, sulfonated styrene-maleic anhydride copolymer, and combinations thereof.

9. The composition of claim 1, wherein the composition further comprises a material selected from the group consisting of a hydrophilic metallic salt, an ionic dispersant, polyvinyl alcohol, and combinations thereof.

10. The composition of claim 9, wherein the hydrophilic metallic salt is present in an amount of about 0.05% to about 5% by weight, based on the total weight of the emulsion.

11. The composition of claim 9, wherein the hydrophilic metallic salt comprises a compound selected from the group consisting of magnesium sulfate, potassium sulfate, lithium sulfate, ammonium sulfate, potassium acetate, ammonium heptamolybdate, and combinations thereof.

12. The composition of claim 9, wherein the ionic dispersant comprises a mixture of a polynaphthalenesulfonic acid, a lignosulfonate, and polynaphthalene sulfonate calcium salt.

13. The composition of claim 9, wherein the polyvinyl alcohol comprises from about 0.05% to about 5% by weight, based on the total weight of the emulsion.

14. The composition of claim 9, comprising:
at least one paraffin wax comprising a melting point from about 54° C. and about 74° C., an oil content from about 0.1% to less than 20% by weight of the wax;
the saponifiable wax, wherein the saponifiable wax comprises a solidification temperature from about 60° C. to about 90° C., a saponification value from about 30 to about 120, and an acid value from about 10 to about 40;
polyvinyl alcohol;
the styrene-maleic anhydride copolymer;
the alkali metal hydroxide; and
water.

15. The composition of emulsion of claim 1, wherein the polyvinyl alcohol comprises from about 0.05% to about 5% by weight, based on the total weight of the composition.

16. The composition of claim 9, comprising:
at least one paraffin wax comprising a melting point from about 54° C. and about 74° C., an oil content from about 0.1% to less than 20% by weight of the wax;
the saponifiable wax, wherein the saponifiable wax comprises a solidification temperature from about 60° C. to about 90° C., a saponification value from about 30 to about 120, and an acid value from about 10 to about 40;
the ionic dispersant;
the styrene-maleic anhydride copolymer;
the alkali metal hydroxide; and
water.

17. The composition of claim 16, wherein the ionic dispersant comprises a material selected from the group consisting of polynaphthalenesulfonic acid, sodium naphthalene sulfonate, a lignosulfonate, polynaphthalene sulfonate calcium salt, and combinations thereof.

18. The composition of claim 16, wherein the ionic dispersant comprises from about 0.25% to about 5.0% by weight based on the total weight of the emulsion.

19. The composition of claim 9, comprising:
at least one paraffin wax comprising a melting point from about 54° C. and about 74° C., an oil content from about 0.1% to less than 20% by weight of the wax;
the saponifiable wax, wherein the saponifiable wax comprises a solidification temperature from about 60° C. to about 90° C., a saponification value from about 30 to about 120, and an acid value from about 10 to about 40;
the hydrophilic metallic salt
an ionic dispersant comprising a mixture of a polynaphthalenesulfonic acid, a lignosulfonate, and polynaphthalene sulfonate calcium salt;
the styrene-maleic anhydride copolymer;
the alkali metal hydroxide; and
water

20. The composition of claim 19, wherein the hydrophilic metallic salt is present in an amount of about 0.05% to about 5% by weight, based on the total weight of the composition and the ionic dispersant from about 0.25% to about 5.0% by weight based on the total weight of the composition.

21. The composition of claim 3, wherein the alkali metal hydroxide comprises from about 0.5% to about 1.5% by weight, based on the total weight of the emulsion.

22. The composition of claim 3, wherein the water comprises from about 55% to about 65% by weight based on the total weight of the emulsion.

23. The composition of claim 1, wherein the emulsion is free of a hydrophilic metallic salt, free of an ionic dispersant, free of polyvinyl alcohol, or combinations thereof.

24. The composition of claim 1, wherein the saponifiable wax comprises a saponifiable wax substitute for montan wax, wherein the a saponifiable wax substitute for montan wax comprises a solidification temperature from about 60° C. to about 90° C., a saponification value from about 30 to about 120, and an acid value from about 10 to about 40

25. A gypsum product comprising gypsum and the composition of claim 1.

26. A method for making a composition according to claim 1, comprising:
providing components comprising:
at least one paraffin wax;
a saponifiable wax;
a styrene-maleic anhydride copolymer; and
an alkali metal hydroxide; and
combining the components in one or more processing steps to form a resultant mixture; and
homogenizing the resultant mixture.

27. The method of claim 26, wherein the components comprise:
at least one paraffin wax comprising a melting point from about 54° C. and about 74° C., an oil content from about 0.1% to less than 20% by weight of the wax;
a saponifiable wax substitute for montan wax, wherein the a saponifiable wax substitute for montan wax comprises a solidification temperature from about 60° C. to about 90° C., a saponification value from about 30 to about 120, and an acid value from about 10 to about 40;
a styrene-maleic anhydride copolymer; and
an alkali metal hydroxide;

28. The method of claim 26, wherein the mixture further comprises a material selected from the group consisting of a hydrophilic metallic salt, an ionic dispersant, water, and combinations thereof.

29. The method of claim 26, wherein the composition further comprises sufficient water to form an emulsion.

30. A method for making an emulsion according to claim 3, comprising:
providing a first mixture comprising at least one paraffin wax, a saponifiable wax, an alkali metal hydroxide, and water;
homogenizing the first mixture;
providing a second mixture comprising a styrene-maleic anhydride copolymer; and
combining the first mixture and the second mixture to form a resultant mixture.
